(19) United States
(12) Patent Application Publication
(10) Pub. No.: US 2025/0179255 A1
(43) Pub. Date: Jun. 5, 2025

(54) BIOPLASTIC COMPOSITION, BIOPLASTIC PRODUCT INCLUDING SAME, AND METHODS OF MANUFACTURE

(71) Applicant: Amino Labs North Incorporated, Lethbridge (CA)

(72) Inventors: Julie LEGAULT, Lethbridge (CA); Justin PAHARA, Lethbridge (CA)

(21) Appl. No.: 18/964,171

(22) Filed: Nov. 29, 2024

Related U.S. Application Data
(60) Provisional application No. 63/605,114, filed on Dec. 1, 2023.

(51) Int. Cl. C08J 3/20; C08L 1/02; C08L 3/02; C08L 5/08; C08L 89/06

(52) U.S. Cl. CPC C08J 3/20; C08L 1/02; C08L 3/02; C08L 5/08; C08L 89/06

(57) ABSTRACT

An improved melt and mold thermoplastic biopolymer composition is provided. Methods of manufacturing the improved composition and a kit containing the materials to manufacture the composition are also provided.

### CROSS REFERENCE TO RELATED APPLICATIONS

This application claims benefit of priority to U.S. Provisional Patent Application No. 63/605,114, entitled “BIOPLASTIC COMPOSITION, BIOPLASTIC PRODUCT INCLUDING SAME, AND METHODS OF MANUFACTURE”, and filed Dec. 1, 2023, which is specifically incorporated by reference herein for all that it discloses or teaches.

### TECHNICAL FIELD

Embodiments herein are generally related to a bioplastic composition, a bioplastic product comprising, in whole or in part, the bioplastic composition, and methods of manufacturing same. Embodiments herein are also generally related to a kit containing the materials to produce at least one bioplastic composition.

### BACKGROUND

In recent years, there has been a growing need for sustainable, safe, and environmentally friendly materials that can be used in the toy industry, especially for children's toys. Traditional plastics, widely used in toy manufacturing, pose a significant environmental challenge due to their persistence in the environment and reliance on petroleum-based sources. Additionally, many conventional plastics contain additives and chemicals that may not be safe for young children, raising health concerns. This has fueled interest in bioplastics-materials derived from renewable sources-as a viable alternative. However, current bioplastics often lack the durability and flexibility to provide a reusable ‘melt and mold’ bioplastic composition that can withstand the demands of children's play while being safe for both children and the environment. Finally, known malleable bioplastic compositions typically lack the thermal and mechanical stability required for the complex shapes and bright colours common in children's toys.

Toys for young children must adhere to strict safety standards, as they may be chewed or mouthed, especially by infants and toddlers. This necessitates the development of a bioplastic composition free from toxic chemicals like BPA, phthalates, and other hazardous substances commonly found in some traditional plastics. A safer, biocompatible plastic made from renewable, biodegradable materials would ensure that even if children interact closely with the toy, there are no risks of chemical exposure. By addressing both environmental sustainability and child safety, an improved melt-and-mold-safe bioplastic for toys could transform the industry, providing a healthier, eco-friendly option that aligns with both consumer demand and environmental goals.

There is a need for an improved bioplastic formulation enabling more intricate, varied designs without compromising structural integrity. It is desirable that the improved bioplastic may be easily molded and re-melted without releasing harmful substances, providing products that are durable, safe, and reliable for young users.

### SUMMARY

According to embodiments, an improved melt and mold bioplastic composition is provided. In some embodiments, the bioplastic composition comprises at least one biopolymer, and at least one additive selected from the group comprising at least one gelling agent, at least one humectant agent, at least one anti-microbial agent, at least one colouring agent, or a combination thereof.

In some embodiments, the at least one biopolymer comprises at least one thermoplastic biopolymer. In some embodiments, the at least one biopolymer is selected from the group consisting of polylactic acid and polylactic acid derivatives, polyhydroxyalkanoates, polycaprolactone, natural plant-based polysaccharides, animal-derived polymers, a nucleic acid, or a combination thereof.

In some embodiments, the at least one gelling agent is selected from the group consisting of at least one heteropolysaccharide, at least one polypeptide, at least one polysaccharide, or a combination thereof.

In some embodiments, the at least one humectant agent is a polysaccharide, a salt, a triol, or a combination thereof.

In some embodiments, the at least one anti-microbial agent is an acid or a base.

In some embodiments, the at least one colouring agent is selected from the group consisting of a synthetic dye, a natural dye, or a combination thereof.

In some embodiments, the bioplastic composition comprises at least one melt and mold three-dimensional product.

According to embodiments, methods of producing at least one bioplastic composition are provided. In some embodiments, the methods comprise providing a first material comprising at least one biopolymer, providing at least one second additive material selected from the group consisting of at least one gelling agent, at least one humectant agent, at least one anti-microbial agent, at least one colouring agent, or a combination thereof, mixing the first and second materials to form a blended mixture, applying heat to the blended mixture to form a substantially molten mixture, removing the heat from the molten mixture, providing at least one form for receiving and shaping the molten mixture, applying the molten mixture to the at least one form and allowing the molten mixture to cool to form the at least one bioplastic composition.

In some embodiments, the methods may comprise adding at least one solvent prior to or after mixing of the first and second materials.

In some embodiments, where remelting is desired, the methods further comprise adding at least one reducing agent to the at least one bioplastic composition.

In some embodiments, the methods further comprise re-applying heat to the at least one bioplastic composition to reform the substantially molten mixture.

In some embodiments, the methods further comprise reapplying the molten mixture to one or more forms to reshape one or more subsequent at least one bioplastic compositions.

According to embodiments, a kit containing materials for producing at least one bioplastic composition is provided. In some embodiments, the kit comprises a first material comprising at least one biopolymer, at least one second material comprising at least one additive selected from one of at least one at least one gelling agent, at least one humectant agent, at least one anti-microbial agent, at least one colouring agent, or a combination thereof, and at least one mold to receive and retain a mixture of the first and the second materials, the at least one mold for shaping the mixture into the at least one bioplastic composition.

In some embodiments, the at least one biopolymer of the kit comprises at least one thermoplastic biopolymer.

In some embodiments, the at least one biopolymer of the kit is selected from the group consisting of polylactic acid and polylactic acid derivatives, polyhydroxyalkanoates, polycaprolactone, natural plant-based polysaccharides, animal-derived polymers, a nucleic acid, or a combination thereof.

In some embodiments, the kit further comprises at least one reducing agent.

In some embodiments, the kit further comprises instructions having steps for manufacturing at least one melt and mold bioplastic composition.

In some embodiments, the first and the second materials are provided in liquid or powder form.

### BRIEF DESCRIPTION OF THE DRAWINGS

Embodiments of the present disclosure will now be described, by way of example only, with reference to the attached Figures.

FIG. 1 shows side perspective view of an example bioplastic product forming two interconnecting shapes, e.g., a first ‘male’ shape and a second, corresponding ‘female’ shape, according to embodiments;

FIG. 2 shows a side perspective view of an alternative embodiment of the bioplastic product of FIG. 1, the alternative embodiment also forming two interconnecting shapes, e.g., a first ‘male’ shape and a second, corresponding ‘female’ shape, according to embodiments;

FIG. 3 shows a perspective view of an example mold for use in manufacturing a bioplastic product shown in FIG. 1 and FIG. 2, according to embodiments; and

FIG. 4 shows an example star-shaped mold (left) and a star-shaped bioplastic product resulting from the mold (right), according to embodiments; and

FIG. 5 shows example mixed-shaped molds resulting from the melting and remolding of the bioplastic products shown in FIGS. 1 and 2.

### DETAILED DESCRIPTION OF EXAMPLE EMBODIMENTS

According to embodiments, an improved bioplastic composition, methods of producing the bioplastic composition, and a kit containing the materials to produce the bioplastic composition are provided. In some embodiments, the improved bioplastic composition provides a melt and mold material for producing a first bioplastic object and, if desired, for reuse in producing (or reproducing) one or more subsequent bioplastic objects, and methods of manufacturing same. In some embodiments, a kit containing the materials to make a first bioplastic composition and then, when desired, to mold and remold the bioplastic composition into subsequent compositions is provided.

According to embodiments, the presently improved bioplastic compositions may advantageously comprise both thermal properties and specific molecular mechanisms to enable molding and re-molding. In some embodiments, the improved bioplastic composition may be designed to be melted into a sufficiently molten material for molding and then cooled into a sufficiently solid material, making the bioplastic composition suitable for thermal processing and reprocessing as many times as desired.

According to embodiments, the presently improved bioplastic compositions may comprise properties such as, without limitation, malleability and strength, non-toxicity, and moisture control (mitigating drying out). For example, the improved bioplastic material may be melted and molded into at least one first article of manufacture and then, as desired, re-melted and re-molded into various other articles of manufacture.

### Definitions

As used herein, the term “about” means a range of values including the specified value, which a person of ordinary skill in the art would consider reasonably similar to the specified value. In certain embodiments, about means within a standard deviation using measurements generally acceptable in the art. In certain embodiments, about means a range extending to +/−10% of the specified value. In certain embodiments, about includes the specified value.

Herein, the term “polymer” refers to a molecule made up of repeating subunits (e.g., polymerized monomers). Polymeric molecules can originate from biological sources, microorganisms, or be synthetically produced, and may comprise at least one polysaccharide, at least one polypeptide, at least one nucleic acid, or a combination thereof. Examples include, without limitation, Polylactic Acid (PLA) and PLA derivatives, e.g., like corn starch and sugarcane, Polyhydroxyalkanoates (PHAs), such as PHB (Polyhydroxybutyrate) and PHBV, which are biodegradable polyesters produced by bacteria; Polycaprolactone (PCL), a biodegradable polymer often blended with other bioplastics; natural plant-based polysaccharides, such as starch, cellulose, agar, and flour; nucleic acids, such as DNA and RNA, which can serve as biodegradable polymers or templates in biotechnological applications; and animal-derived polymers like polypeptides, chitin, chitosan, and gelatin, and polypeptides containing sulfur (e.g., thiol groups and thiolated polysaccharides), which can be used to promote the formation of disulfide bonds (e.g., during molding), and to reduce the formation of disulfide bonds (e.g., melting, and re-melting) where reducing agents, such as DTT (Dithiothreitol), TCEP (Tris(2-carboxyethyl)phosphine), glutathione, or THPP (Tris(hydroxypropyl)phosphine), may be used.

As used herein, the terms “biopolymer”, “natural polymer”, and “biologically-derived polymer”, refers to a polymer derived from a living organism, which is subjected to a mechanical, thermal, and/or chemical process to render it useful in the formation of a melt and mold bioplastic.

As used herein, the term “bioplastic”, refers to a bioplastic material manufactured from a composition comprising, in whole or in part, at least one biologically-derived polymer.

As used herein, the term “concentration”, refers to the concentration of a substance in a solution, expressed as a percentage of the weight of the solute (in grams) per volume of the solution (in milliliters). For example, concentrations described herein may be provided within a range of approximately 0.1% w/v, meaning 0.1 grams of solute in 100 mL of solution, up to 5% w/v, meaning 5 grams of solute in 100 mL of solution, or any concentrations therebetween. Without limitation, the presently described concentration range of about 0.1% w/v to about 5% w/v are not intended to be precise, and may be adjusted depending upon the intended application, desired formulation, and/or requirements of the bioplastic composition. It should be appreciated that, within the ranges provided, concentrations as low as 0.1% w/v may be used to achieve effective results in applications where minimal quantities are sufficient, while concentrations up to 5% w/v may be suitable for formulations requiring enhanced quantities. This flexibility allows the substance to be tailored to various end uses without compromising stability or malleability. All concentrations within this range, including intermediate values, are contemplated as part of the embodiments.

As used herein, the term “thermoplastic” and “thermoplastic biopolymer”, refer to a bioplastic composition that can be melted and molded, and then remelted and remolded, using temperature, making it suitable for thermal processing and reprocessing. In some embodiments, it is contemplated that a thermoplastic biopolymer may soften when heated and harden when cooled, enabling the material to be shaped and reshaped multiple times without significant degradation of material properties. Without limitation, it is understood that, upon heating, the thermoplastic material's polymer chains become flexible, allowing it to be shaped and reshaped and, upon cooling, the material re-solidifies, retaining a new form, enabling thermal reprocessing and reusability.

As used herein, the term “additives” means a composition or chemical ingredient added to the presently described bioplastic composition. In some embodiments, the additives may be of natural origin. The additives may have the function of modulating the properties of the bioplastic composition in order to give the composition certain desired mechanical, visual, olfactory, gustatory, and/or textural properties according to the type of bioplastic composition desired to be obtained by means of the presently described methods, such as gelling agents, humectant agents, mold-enhancing or anti-microbial agents, combinations thereof, and the like. Although compositions and bioplastic compositions comprising certain

biopolymers are described herein, such descriptions are for explanatory purposes only and the presently described compositions may contain any chemical ingredients achieving the embodiments. By way of example, the presently described compositions may comprise any desired use properties and applicable chemical ingredient including, without limitation, carbohydrates, lipids, polypeptides, amino acids, triols, glycerides, polysaccharides, combinations thereof, and the like.

### Bioplastic Compositions

According to embodiments, improved bioplastic compositions are provided. In some embodiments, the improved bioplastic compositions may comprise, in whole or in part, at least one biologically-derived polymer or ‘biopolymer’ and at least one additive.

In some embodiments, the improved bioplastic composition may comprise, in whole or in part, at least one thermoplastic biopolymer, wherein, without limitation, the at least one thermoplastic biopolymer may be designed to comprise reversible disulfide bonds, enabling controlled melting and re-melting for shaping and reshaping of the bioplastic composition. For example, without limitation, the at least one thermoplastic biopolymer may be configured such that oxidation of sulfur atoms to disulphide bonds during molding occurs due to molecular oxygen.

In some embodiments, the improved bioplastic composition may further comprise at least one gelling agent, such agent operative to modify the viscosity and control the gelation of the composition, ensuring the desired semi-soli, gel-like consistency for improved handling. In some embodiments, the at least one gelling agent may serve to enhance the melt strength and reduce sagging during molding and remolding of the composition, providing sufficient rigidity and flexibility of the product. In some embodiments, the at least one gelling agent may be selected from the group consisting of at least one heteropolysaccharide, such as agar or agarose, and/or at least one polypeptide, such as gelatin, polycysteine, etc. It should be understood that the choice and quantity of gelling agent can depend upon the desired properties of the thermoplastic composition, for e.g., bioplastics ranging from flexible “gummy” bioplastics to hard, rigid bioplastics.

In some embodiments, the improved bioplastic composition may further comprise at least one humectant agent, such agent operative to retain moisture (e.g., water vapour), ensuring the composition has sufficient moisture and stability. In some embodiments, the at least one humectant agent may be a polysaccharide, such as starch, microcrystalline cellulose, cellulose, glycogen, or the like, or salts, such as sodium chloride, potassium, chloride, magnesium chloride, or other suitable molecules having substantial hydrogen bonding capabilities (e.g., hyaluronic acid, pyroglutamic acid, etc.). It should be understood that the choice and quantity of humectant agent can depend upon the desired properties of the thermoplastic composition.

In some embodiments, the improved bioplastic composition may further comprise at least one anti-microbial agent, such agent operative to prevent or reduce the occurrence of unwanted microbial growth. The use of at least one anti-microbial agent may enhance the longevity, appearance, and functionality of the thermoplastic composition, particularly in environments prone to high humidity or contamination. In some embodiments, the at least one anti-microbial agent may be selected from the group consisting of an acid or a base, such as sodium carbonate, citric acid, acetic acid, or the like. It should be understood that the choice and quantity of anti-microbial agent can depend upon the desired properties of the thermoplastic composition.

In some embodiments, the improved bioplastic composition may further comprise at least one colouring agent, such agent operative to impart colour to the composition. The use of at least one colouring agent may enhance the aesthetic appeal, provide product differentiation (e.g., for educational purposes), or serve functional purposes, such as indicating safety or specific properties. In some embodiments, the at least one colouring agent may be selected from the group consisting of a synthetic dye, or a natural dye, such as turmeric, betanin, chlorophyll, or the like. It should be understood that the choice and quantity of colouring agent can depend upon the desired properties of the thermoplastic composition.

In some embodiments, the improved bioplastic composition may further comprise at least one decorative element, such element enhancing the physical properties of the composition. In some embodiments, the decorative element may be selected from the group consisting of sparkles, glitter, hair, natural objects, scents, and the like. In some embodiments, the decorative element may comprise a clasp or ring for use as jewelry, accessories, a keychain, and the like. It should be understood that the presently described bioplastic composition may maintain its shape and be sufficiently strong for use as jewelry, as an accessory, and the like.

In some embodiments, the improved bioplastic composition may further comprise at least one reducing agent, such element reducing the formation of disulfide bonds for melting and re-melting the bioplastic composition. In some embodiments, the reducing agent may be selected from the group consisting of DTT (Dithiothreitol), TCEP (Tris(2-carboxyethyl)phosphine), glutathione, THPP (Tris(hydroxypropyl)phosphine), or the like.

### Methods of Manufacture

According to embodiments, methods of producing an improved bioplastic composition are provided. In some embodiments, the bioplastic composition may comprise a mixture of at least one biologically-derived polymer or ‘biopolymer’ and at least one additive.

In some embodiments, the improved bioplastic composition may comprise, in whole or in part, at least one thermoplastic biopolymer and the methods may comprise melt processing of the at least one thermoplastic biopolymer. For example, melt processing may comprise applying heat to the thermoplastic biopolymer, allowing the thermoplastic biopolymer to form a substantially fluid material (or ‘molten mixture’) and, when desired, removing the heat, allowing the at least one biopolymer to reestablish upon cooling.

In some embodiments, the methods of producing the bioplastic composition may comprise providing a first material comprising the at least one biopolymer and providing at least one second additive material selected from the group consisting of at least one gelling agent, at least one humectant agent, at least one anti-microbial agent, at least one colouring agent, or a combination thereof. In some embodiments, the at least one first and/or second materials may be provided in powder or liquid form, with any other suitable form also being contemplated.

In some embodiments, the methods may further comprise mixing the first and second materials. In some embodiments, the methods may comprise heating one or more of the first and second materials prior to or after mixing of the first and second materials.

In some embodiments, the methods may further comprise adding at least one solvent to the mixture comprising the at least one biopolymer and the at least one additive. For example, the methods may comprise adding a liquid, such as an aqueous solvent including, without limitation, pure water, water, with or without a buffering agent, glycerol, acetic acid, colloid (e.g., milk) or any other suitable liquid or combination of liquids, to the mixture to create a malleable composition that can be poured into at least one mold for shaping the composition. In some embodiments, the at least one solvent may be added to at least one of the first and second materials prior to or after mixing of the first and second materials.

In some embodiments, the methods may comprise applying heat to the blended mixture of first and second materials, producing a substantially molten mixture that can be poured into at least one mold for shaping the composition. In some embodiments, the at least one solvent may be added to the mixture prior to or after applying heat. In some embodiments, the methods may comprise removing heat from the at least one molten mixture. In some embodiments, the methods of applying and removing heat may be combined with the step of applying at least one solvent and repeated as many times as required to achieve the desired molten mixture.

In some embodiments, the methods may comprise providing at least one form for receiving and shaping the molten mixture and pouring the molten mixture into the at least one mold to form a bioplastic composition having the at least one shape. For example, the mold may be configured to receive the molten mixture and for shaping the mixture into the desired form.

In some embodiments, the methods may further comprise adding at least one reducing agent to the at least one bioplastic composition. For example, where re-melting of the at least bioplastic composition is desired, the methods may comprise adding the at least one reducing agent and re-applying heat to the composition in order to re-achieve a substantially molten mixture. In some embodiments, the re-melted composition may then be reapplied to one or more molds to form one or more subsequently formed bioplastic compositions.

According to embodiments, at least one kit containing materials for producing at least one bioplastic composition is provided. In some embodiments, the kit may comprise at least one first material comprising a biologically-derived polymer or ‘biopolymer’. In some embodiments, the biopolymer may comprise, in whole or in part, at least one thermoplastic polymer. In some embodiments, the biopolymer may be provided in powder form, or in any other suitable form.

In some embodiments, the kit may comprise at least one second material, the second material being an additive selected from one of at least one at least one gelling agent, at least one humectant agent, at least one anti-microbial agent, at least one colouring agent, or a combination thereof. In some embodiments, the kit may comprise at least one decorative agent.

In some embodiments, the materials for producing the at least one bioplastic composition may be provided in one or more packages, such as sealed bags or containers, along with instructions providing the steps for mixing and processing the materials to produce the melt and mold bioplastic. The instructions may further include the steps for remelting and remolding the composition any number of times, producing any number of shapes.

In some embodiments, the kit may comprise at least one mold forming a shape for receiving and retaining the at least one bioplastic composition mixture, wherein the at least one biopolymer may be melted and remelted to shape and create the at least one bioplastic composition having a three-dimensional shape.

Herein, the presently improved bioplastic composition, methods of manufacture, and corresponding kit will be described in more detail by means of the following examples, such examples in no way limiting the presently described embodiments.

### Example 1

### Moldable Clasp

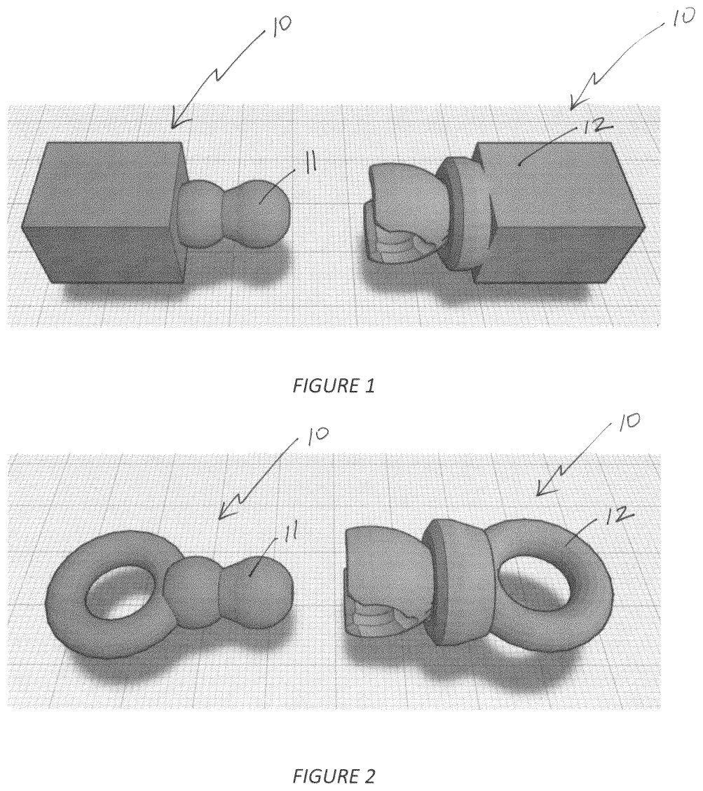

The presently described bioplastic composition and methods of producing same will now be described having regard to FIGS. 1-5.

In some embodiments, having regard to FIGS. 1 and 2, methods of producing the presently improved bioplastic composition may comprise producing at least two bioplastic compositions 10, the two compositions 10 being produced to correspondingly connect (or interconnected) one with the other. In some embodiments, the two compositions 10 may be produced to form a clasp, such as a jewelry clasp comprising a first ‘male’ end 11 and a second ‘female’ end 12. By way of example only, first male end 11 may form a spherical ball portion for corresponding to and connecting with second female 12 forming a hollow, spherical-shaped socket-type cavity for accommodating male end 11. In this manner, the example bioplastic product may comprise two portions designed to provide a smooth, low-friction, snap-fit connection, such as may be desired to connect and disconnect a piece of jewelry, e.g., necklace, bracelet, anklet, or the like. It should be readily understood that the presently described clasp connector is provided for example purposes only, and that any form, shape, and configuration of bioplastic product is contemplated. It should be readily understood, having regard to FIG. 5, that transitional shapes 10 may be produced during remelting and remolding of the bioplastic compositions. For example, where the bioplastic compositions 10 are re-melted and reshaped, one or more additional shapes (e.g., three dinosaurs) may be transitioned into other shapes (e.g., a swamp monster) for further use in play.

In some embodiments, the methods may comprise:
a) providing a first material comprising at least one biologically-derived polymer or ‘biopolymer’, wherein the first material is provided in powder form.

Recipe 1—Hard Plastic: In a first example embodiment, the first material may comprise chitin, chitosan, or a combination thereof, at a concentration of approximately 6% w/v to approximately 12% w/v, such concentration selected for optimized ‘hardness’ of bioplastic composition.

Recipe 2—Soft Plastic: In a second example embodiment, the first material may comprise a starch at a concentration of approximately 6% w/v to 7% w/v, and preferably approximately 6.7% w/v. In a corresponding kit, a bag labelled #1 may be provided, the bag #1 containing the appropriate quantity of the first material. In this second example embodiment, the bag #1 may contain approximately 4 g of starch.

In this second example embodiment, the first material may further comprise a mixture of biopolymers including, without limitation, gelatin (10% w/v), rice powder (6.7% w/v), cellulose (6.7% w/v), and baking soda (1.7% w/v). In a corresponding kit, a bag labelled #2 may be provided, the bag #2 containing the appropriate quantity of the additional first materials. In this second example embodiment, the bag #2 may contain approximately 6 g of gelatin, 4 g of rice powder, 4 g cellulose, and 1 g of baking soda.

In this second example, any suitable first material optimized to form a soft plastic that dries hard after a predetermined period of time, such as 24-48 hours, or that stays soft if kept in a reduced air environment, such as a substantially sealed plastic bag or container, is contemplated.

Recipe 3—Rubberize String having Varying Flexibility: In a third example embodiment, the materials may be selected to optimize the desired flexibility (or stiffness) of the at least one bioplastic composition. For example, in this third example embodiment, the first material may comprise a vegetable starch at a concentration of approximately 6% w/v to 14% w/v, and preferably approximately 6.7% w/v to 13.3% w/v.
b) providing a second material comprising at least one additive, wherein the additive is selected from the group consisting of at least one at least one gelling agent, at least one humectant agent, at least one anti-microbial agent, at least one colouring agent, or a combination thereof, wherein the at least one additive may be provided in any form suitable for use, including powder or liquid form. In some embodiments, the at least one second material may comprise a solvent, serving to mix the first and second materials into a blended mixture.

Recipe 1: In the first example embodiment, the second material may comprise a solvent. For example, the second material may be water at a volume of approximately 100 mL.

In the first example embodiment, the second material may further comprise at least one humectant agent. For example, the second material may be glycerol, at a concentration of approximately 2% w/v to 3% w/v, and preferably 2.5% w/v to 3% w/v (or 2.5 mL-3 mL).

In the first example embodiment, the second material may further comprise at least one anti-microbial agent. For example, the second material may be acetic acid at a concentration of approximately 5% w/v.

Recipe 2: In the second example embodiment, the second material may comprise a solvent. For example, the second material may be water at a volume of approximately 60 mL.

In the second example embodiment, the second material may further comprise at least one humectant agent. For example, the second material may be glycerol, at a concentration of approximately 3% w/v to 4% w/v, and preferably 3.3% (or 2mL).

In the second example embodiment, the second material may comprise at least one dye, such as a natural dye at a concentration of less than 1% w/v.

Recipe 3: In the third example embodiment, the second material may be selected to provide at least one bioplastic composition having varying flexibility. For example, for a bioplastic composition having:

Minimal (less) flexibility: the at least one second material may be a solvent, such as water, at a volume of approximately 15 mL, glycerol at a concentration of approximately 6.7% w/v (1mL), and gelatin at a concentration of approximately 20% w/v (3 g). In some embodiments, the second material may also comprise at least one dye, such as a natural dye at a concentration of less than 1% w/V.

Moderate flexibility: the at least one second material may be a solvent, such as water, at a volume of approximately 15 mL, glycerol at a concentration of approximately 6.7% w/v (1 mL), and gelatin at a concentration of approximately 6.7% w/v (1 g). In some embodiments, the second material may also comprise at least one dye, such as a natural dye at a concentration of less than 1% w/v.

Substantial (most) flexibility: the at least one second material may be a solvent, such as water, at a volume of approximately 15 mL, glycerol at a concentration of approximately 13.3% w/v (2 mL), and gelatin at a concentration of approximately 20% w/v (3 g). In some embodiments, the second material may also comprise at least one dye, such as a natural dye at a concentration of less than 1% w/v.
c) combining the first and second materials to form a blended mixture. In some embodiments, mixing the first and second materials may comprise stirring or agitating the mixture until the materials have dissolved;
d) applying heat to the blended mixture. In some embodiments, heat may be applied until a rolling boil of the blended mixture is achieved.

In some embodiments, the methods may comprise heating the second material (i.e., solvent) prior to or after mixing with the first material. In some embodiments, the methods may comprise heating the second material, such as water, to a boil, prior to or after mixing the first and second materials. In some embodiments, the methods may comprise mixing (agitating or stirring) the first and second materials until dissolved. The methods may optionally further comprise applying addition heat to the mixture and continuing the agitation until smooth.

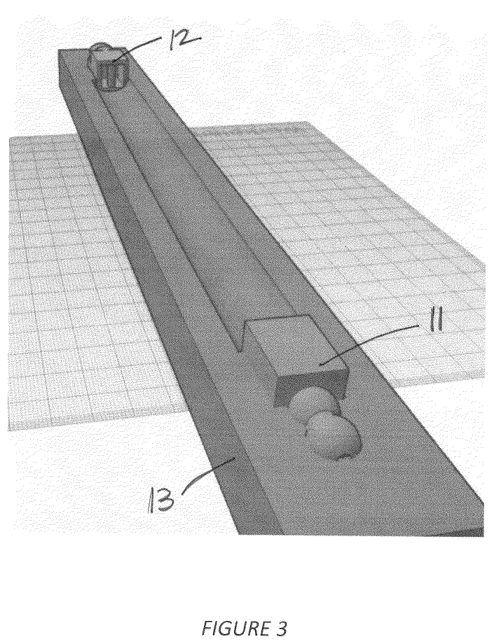

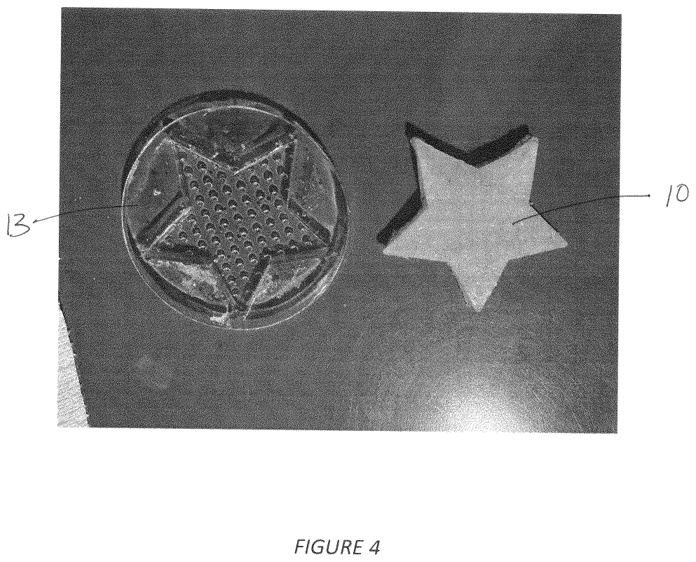

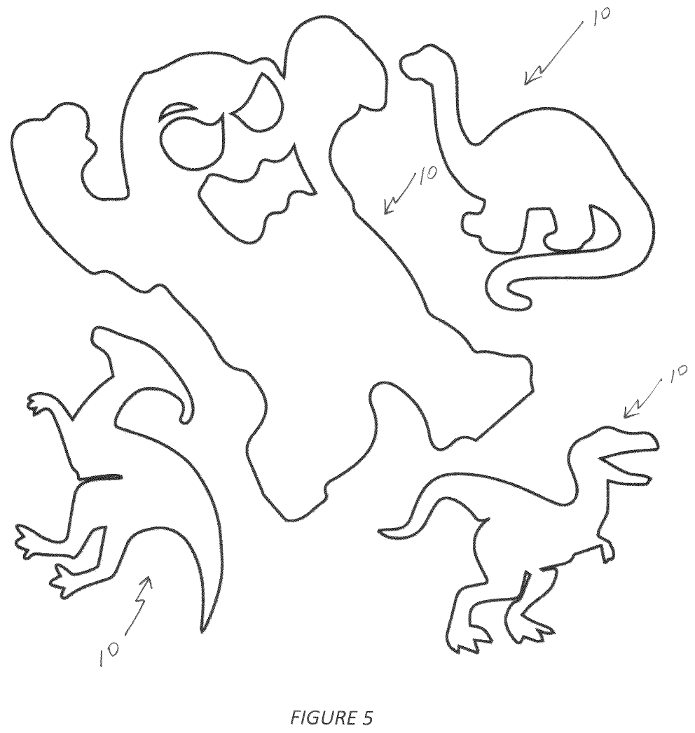

In some embodiments, the methods may further comprise temporarily removing the heat and allowing the mixture to cool slowly, with or without additional stirring, and reapplying the heat for an equal or shorter duration of time, to achieve an annealed, molten mixture;
e) applying the molten mixture to at least one mold. In some embodiments, having regard to FIG. 3, bioplastic compositions formed into corresponding male and female ends 11,12, may be positioned within one or more molds 13 for use in forming a bioplastic composition, or for interconnecting bioplastic compositions. For example, where a user wishes to manufacture a bracelet or other piece of jewelry, user may position ends 11,12 into one or more molds, and then subsequently add the molten mixture so as to connect the ends 11,12 to form the bracelet. That is, in some embodiments, one or more molds 13 may serve to shape an individual bioplastic composition (e.g., a star, FIG. 4), or may be used as scaffolding to connect or interconnect one or more bioplastic compositions 11,12 (e.g., a bracelet, FIG. 3), or the like;
f) allowing the mixture to cool and gelate until a cured bioplastic product is formed; and
e) removing the bioplastic product from mold 13 for use as desired.

In some embodiments, the methods may optionally comprise allowing the cured bioplastic product to dry for additional time to alter certain properties of the product, such as the tensile strength.

In some embodiments, when desired, the methods may further comprise re-applying heat to the bioplastic product. In some embodiments, re-heating of the product may further comprise adding additional fluid.

In some embodiments, the methods may then comprise applying the recreated molten mixture to at least one mold and allowing the mixture to cure. For example, having regard to FIG. 4, at least a portion of the mixture may be applied to a mold 13 for forming a bioplastic composition 10 having a geometric shape, such as a star. In such embodiments, the present methods advantageously provide a melt and mold bioplastic composition that may be formed and reformed into any number of desired shapes.

In some embodiments, optionally, the methods may further comprise adding at least one decorative component, such as a colouring dye, to produce bioplastic products having different colours, and/or combining multiple molded bioplastic materials of different colours and then re-melting them to change their colour. In some embodiments, other chemicals and/or objects (e.g., without limitation, glitter/sparkles, hair, fur) may be added to the bioplastic product, altering the appearance, smell, or material properties of the bioplastic product.

In some embodiments, advantageously, the presently described melt and mold bioplastic product may be used to manufacture and remanufacture the product should the product dry out or be over-handled, or should it become damaged, torn, broken, or the like. In some embodiments, the presently improved bioplastic product may be used by individuals by performing and reperforming the presently described methods.

In some embodiments, a kit containing materials and instructions for producing the at least one bioplastic product may be provided. For example, the kit may comprise, at least, the materials for manufacturing at least one bioplastic composition, as well as specific ingredient quantities, or recipes, for manufacturing bioplastic products, as desired. In some embodiments, the kit may also contain at least one pre-manufactured bioplastic composition, such composition manufactured by any suitable means including additive manufacturing, or 3D printing. For example, in some embodiments, the kit may contain at least one pre-manufactured bioplastic composition and instructions for use in “stringing” the compositions together to form jewelry, e.g., a bracelet or necklace.

In some embodiments, advantageously, the presently described “melt and mold” bioplastic product may be used to create any number, shape, and size of toys, figurines, jewelry, hair ties, accessories, key chains, educational objects, and the like. The user may simply repeat all or some of the above referenced steps 1 through 8 using one or more molds, as desired.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and the described portions thereof.

We claim:

1. A bioplastic composition comprising:
at least one biopolymer, and
at least one additive selected from the group comprising at least one gelling agent, at least one humectant agent, at least one anti-microbial agent, at least one colouring agent, or a combination thereof.

2. The bioplastic composition of claim 1, where the at least one biopolymer comprises at the at least one thermoplastic biopolymer.

3. The bioplastic composition of claim 1, wherein the at least one biopolymer is selected from the group consisting of polylactic acid and polylactic acid derivatives, polyhydroxyalkanoates, polycaprolactone, natural plant-based polysaccharides, polypeptide, animal-derived polymers, a nucleic acid, or a combination thereof.

4. The bioplastic composition of claim 1, wherein the at least one gelling agent is selected from the group consisting of at least one heteropolysaccharide, at least one polypeptide, or a combination thereof.

5. The bioplastic composition of claim 1, wherein the at least one humectant agent is a polysaccharide, a salt, triol, or a combination thereof.

6. The bioplastic composition of claim 1, wherein the at least one anti-microbial agent is an acid or a base.

7. The bioplastic composition of claim 1, wherein the at least one colouring agent is selected from the group consisting of a synthetic dye, a natural dye, or a combination thereof.

8. The bioplastic composition of claim 1, wherein the bioplastic composition comprises at least one melt and mold three-dimensional product.

9. A method of producing at least one bioplastic composition, the method comprising:
providing a first material comprising at least one biopolymer, providing at least one second material selected from the group consisting of at least one gelling agent, at least one humectant agent, at least one anti-microbial agent, at least one colouring agent, or a combination thereof,
mixing the first and second materials to form a blended mixture,
applying heat to the blended mixture to form a substantially molten mixture,
removing the heat from the molten mixture,
providing at least one form for receiving and shaping the molten mixture,
applying the molten mixture to the at least one form and allowing the molten mixture to cool to form the at least one bioplastic composition.

10. The method of claim 9, wherein the methods further comprise adding at least one solvent prior to or after mixing of the first and second materials.

11. The method of claim 9, where remelting is desired, adding at least one reducing agent to the at least one bioplastic composition.

12. The method of claim 11, wherein the method further comprises re-applying heat to the at least one bioplastic composition to reform the substantially molten mixture.

13. The method of claim 12, wherein the method further comprises reapplying the molten mixture to one or more forms to reshape one or more subsequent at least one bioplastic compositions.

14. A kit containing materials for producing at least one bioplastic composition, the kit comprising:
a first material comprising at least one biopolymer,
at least one second material comprising at least one additive selected from one of at least one at least one gelling agent, at least one humectant agent, at least one anti-microbial agent, at least one colouring agent, or a combination thereof, and
at least one mold to receive and retain a mixture of the first and the second materials, the at least one mold for shaping the mixture into the at least one bioplastic composition.

15. The kit of claim 14, wherein the at least one biopolymer comprises at least one thermoplastic biopolymer.

16. The kit of claim 14, wherein the at least one biopolymer is selected from the group consisting of polylactic acid and polylactic acid derivatives, polyhydroxyalkanoates, polycaprolactone, natural plant-based polysaccharides, animal-derived polymers, polypeptide, a nucleic acid, or a combination thereof.

17. The kit of claim 14, wherein the kit further comprises at least one reducing agent.

18. The kit of claim 14, wherein the kit further comprises instructions having steps for manufacturing at least one melt and mold bioplastic composition.

19. The kit of claim 14, wherein the first and the second materials are provided in liquid or powder form.
